(19) United States
(12) Patent Application Publication
(10) Pub. No.: US 2024/0385393 A1
(43) Pub. Date: Nov. 21, 2024

(54) OPTICAL COUPLING ELEMENT, ARRANGEMENT, AND TRANSCEIVER

(71) Applicant: Innolume GmbH, Dortmund (DE)

(72) Inventors: Alexey Kovsh, Dortmund (DE); Aleksei Borodkin, Dortmund (DE); Vladislav Bougrov, Dortmund (DE); Alexey Gubenko, Dortmund (DE); Sergey Mikhrin, Dortmund (DE)

(21) Appl. No.: 18/582,523

(22) Filed: Feb. 20, 2024

Related U.S. Application Data
(63) Continuation-in-part of application No. 18/464,087, filed on Sep. 8, 2023.
Application No. 18/464,087 is a continuation-in-part of application No. 18/318,526, filed on May 16, 2023.

(51) Int. Cl. G02B 6/42

(52) U.S. Cl. CPC G02B 6/4206

(57) ABSTRACT

An optical coupling element is configured to be positioned between and optically couple a first optical component configured to transmit a light beam, and a second optical component configured to receive light. The optical coupling element comprises a glass coupler body having a receiving side surface and an opposite transmitting side surface. The glass coupler body comprises a converging member configured to reduce divergence of light entering the glass coupler body via the receiving side surface; and a coupling waveguide extending within the glass coupler body between the converging member and an output facet on the transmitting side surface and being configured to transmit light from the converging member to the output facet.

### CROSS-REFERENCE TO RELATED APPLICATIONS

The present application is a continuation-in-part of U.S. Non-Provisional patent application Ser. No. 18/464,087, entitled “OPTICAL COUPLING ELEMENT, ARRANGEMENT, AND TRANSCEIVER”, and filed on Sep. 8, 2023. U.S. Non-Provisional patent application Ser. No. 18/464,087 is a continuation-in-part of U.S. Non-Provisional patent application Ser. No. 18/318,526, entitled “OPTICAL COUPLER, OPTICAL COUPLING ASSEMBLY, AND TRANSCEIVER”, and filed on May 16, 2023. The entire contents of each of the above-listed application are hereby incorporated by reference for all purposes.

### BACKGROUND

In data communication, optical data communication technology may provide excellent performance, for example, from data transfer speed, space-efficiency, energy-efficiency, and/or cost-efficiency points of view.

An important factor affecting the feasibility of optical data communication and transfer systems is the efficiency of optical coupling between different optical components in various devices such as optical transceivers. Optical coupling is in crucial role both in transmitting and receiving stages of optical data communication systems. This is the case especially in the case of active optical components or elements such as ones comprising semiconductor lasers or arrays of the same, wherein light transmitted by such active optical components or elements is to be coupled into other optical components or elements. Differences in optical properties of transmitting and receiving optical components, such as numerical apertures or mode field or beam shapes or sizes, may easily result in significant coupling losses. In addition, even with the two optical components having similar optical properties, inaccuracies in aligning opposite optical components may decrease the coupling efficiency. On the other hand, as the requirements of the aligning accuracy increase, the manufacturing processes of optical coupling arrangements may become less efficient and slower.

In addition to data communication applications, corresponding challenges related to optical coupling may be present in other applications such as in optical sensing.

Improved solutions are needed for high efficiency optical coupling arrangements.

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In a first aspect, an optical coupling element is disclosed, which is configured to be positioned between, and optically couple, a first optical component configured to transmit a light beam and a second optical component configured to receive light. The optical coupling element comprises a glass coupler body having a receiving side surface and an opposite transmitting side surface. The glass coupler body comprises:
a converging member configured to reduce, in accordance with converging characteristics, divergence of light entering the glass coupler body via the receiving side surface; and
a coupling waveguide extending within the glass coupler body between the converging member and an output facet on the transmitting side surface and being configured to transmit light from the converging member to the output facet.

In a first embodiment, the converging member comprises a lens, such as an elliptical cylindrical lens.

In an embodiment which may be in accordance with the previous embodiment, the converging member forms a local extension outwards of the receiving side surface.

In an alternative embodiment, which may be in accordance with the first embodiment above, the converging member is formed within the glass coupler body.

In an embodiment which may be in accordance with any of the previous embodiments, the coupling waveguide is configured to narrow towards the output facet.

In an embodiment which may be in accordance with any of the previous embodiments, the coupling waveguide is configured to have a curved section.

In an embodiment which may be in accordance with any of the previous embodiments, the coupling waveguide is configured to have a curved section narrowing towards the output facet.

In an embodiment which may be in accordance with any of the two previous embodiments, the curved section or the curved section narrowing towards the output facet has a length of less than or equal to 200 μm.

In an embodiment which may be in accordance with any of the previous embodiments, the coupling waveguide is configured to have a straight waveguide section having a substantially constant cross-section.

In an embodiment which may be in accordance with any of the previous embodiments, the coupling waveguide has a first end at the side of the receiving side surface and a second end at the side of the transmitting side surface, at least one of the first and the second ends lying at an edge separation distance of 2 to 20 μm from the transmitting or receiving side surface, respectively.

In an embodiment which may be in accordance with any of the previous embodiments, the coupling waveguide has a first end at the side of the receiving side surface, the converging member has an optical axis and a receiving interface having a radius of curvature R at the optical axis, the first end lying at a converging member separation distance of 0.5 to 1.5 R, defined along the optical axis, from the receiving interface.

In an embodiment which may be in accordance with any of the previous embodiments, the coupling waveguide has a first end at the side of the receiving side surface and a first facet at the first end, the first facet lying at a non-zero angle relative to the receiving side surface.

In an embodiment which may be in accordance with any of the previous embodiments, at least part of the coupling waveguide is formed by direct laser writing.

In an embodiment which may be in accordance with any of the previous embodiments, the glass coupler body has a cavity therein dividing the coupling waveguide into a first waveguide part between the cavity and the converging member, and a second waveguide part between the cavity and the transmitting face.

In an embodiment in accordance with the previous embodiment, the optical coupling element comprises an intermediate optical component, such as an isolator, positioned in the cavity.

In an alternative embodiment, the cavity has two opposite reflective surfaces lying tilted relative to the coupling waveguide to form a virtually imaged phase array VIPA configured to spatially separate multi-wavelength light entering the cavity from the first waveguide part into a first wavelength component transmitted to the second waveguide part and at least one additional wavelength component, the glass coupler body comprising at least one additional waveguide part between the cavity and the transmitting face positioned to receive the at least one additional waveguide component.

In an embodiment which may be in accordance with any of the previous embodiments, the glass coupler body comprises an array of a plurality of converging members and a plurality of coupling waveguides between the converging members and output facets on the transmitting side surface.

In an embodiment in accordance with the previous embodiment, each of the coupling waveguides comprises an input waveguide part, an intermediate waveguide part, and an output waveguide part, the intermediate waveguide parts of at least two coupling waveguides lying in a light coupling connection with each other enabling coupling of light signals between the at least two coupling waveguides.

In an embodiment in accordance with the previous embodiment, the intermediate waveguide parts of the at least two coupling waveguides form a joint waveguide.

In a second aspect, in a first alternative, an optical coupling arrangement is disclosed, comprising:
a first optical component having a transmitting facet, configured to transmit a light beam with a beam divergence corresponding to a first numerical aperture out of the transmitting facet;
a first optical coupling element in accordance with the optical coupling element in accordance with the first aspect or any embodiment thereof, the converging member being configured to reduce the beam divergence of the light beam transmitted by the first optical component; and
a second optical component with a second numerical aperture, having a receiving facet, configured to receive light via the receiving facet.

The first and the second optical components may be positioned with the transmitting and receiving facets thereof facing each other, possibly mutually misaligned by a non-zero optical component misalignment. The optical coupling element is positioned between the first and the second optical components with the converging member and the transmitting facet facing each other, possibly mutually misaligned by a first coupler misalignment to optically couple, with a coupling efficiency, the first and the second optical components by transmitting light of the light beam to the output facet and further to the receiving facet.

The coupling waveguide may then be configured to reduce effect(s) of the possible misalignments, possible difference between the first and the second numerical apertures, and/or the converging characteristics on the coupling efficiency.

In a second alternative of the second aspect, an optical coupling arrangement is disclosed, comprising:
a first optical component having a transmitting facet, configured to transmit a light beam with a beam divergence corresponding to a first numerical aperture out of the transmitting facet;
a first optical coupling element in accordance with the optical coupling element in accordance with the first aspect or any embodiment thereof, the converging member being configured to reduce the beam divergence of the light beam transmitted by the first optical component;
a second glass coupler body having a second receiving side surface and an opposite second transmitting side surface, the second glass coupler body comprising a second coupling waveguide extending within the second glass coupler body between a second input facet on the second receiving side surface and a second output facet on the second transmitting side surface and being configured to transmit light from the second input facet to the second output facet;
an optical fiber such as a passive optical fiber connected to, and optically coupling, the output facet of the first optical coupling element and the second input facet; and
a second optical component with a second numerical aperture, having a receiving facet, configured to receive light via the receiving facet.

The first optical coupling element and the first optical component are positioned with the converging member and the transmitting facet facing each other, possibly mutually misaligned by a non-zero first coupler misalignment. Correspondingly, the second glass coupler body and the second optical component are positioned with the second output facet and the receiving facet facing each other, possibly mutually misaligned by a non-zero second coupler misalignment.

The optical arrangement is configured to optically couple, with a coupling efficiency, the first and the second optical components by transmitting light of the light beam to the output facet and further to the receiving facet.

One or both of the coupling waveguide of the glass coupler body of the first optical coupling element and the second coupling waveguide may then be configured to reduce effect(s) of the first and/or second coupler misalignments, possible difference between the first and the second numerical apertures, and/or the converging characteristics on the coupling efficiency.

In an embodiment, the first numerical aperture is at least 0.2, for example, at least 0.3.

In an embodiment which may be in accordance with any of the previous embodiments, the second numerical aperture is smaller than the first numerical aperture.

In an embodiment which may be in accordance with the previous embodiment, the second numerical aperture is less than or equal to 0.1.

In an embodiment which may be in accordance with any of the previous embodiments of the second alternative, the optical fiber is connected to at least one of the output facet of the glass coupler body of the first optical coupling element and/or the second input facet by a connector element mounted on the transmitting side surface of the glass coupler body of the first optical coupling element and/or on the second receiving side surface, respectively.

In an embodiment which may be in accordance with any of the previous embodiments, the coupling waveguide of the glass coupler body of the first optical coupling element has an input numerical aperture smaller than the first numerical aperture.

In an embodiment which may be in accordance with any of the previous embodiments, the coupling waveguide of the glass coupler body of the first optical coupling element has an output numerical aperture smaller than or equal to the second numerical aperture.

In an embodiment which may be in accordance with any of the previous embodiments, the first coupler misalignment comprises a horizontal offset of less than or equal to 1 μm.

In an embodiment which may be in accordance with any of the previous embodiments, the first coupler misalignment comprises a vertical offset of less than or equal to 2 μm.

In an embodiment which may be in accordance with any of the previous embodiments, the coupling waveguide of the glass coupler body of the first optical coupling element and/or the second coupling waveguide has a refractive index higher than that of the surrounding glass coupler body.

In an embodiment which may be in accordance with any of the previous embodiments, the first optical component comprises an active optical component, such as a semiconductor laser, an optical amplifier, or an optical modulator.

In an embodiment which may be in accordance with any of the previous embodiments, at least one of the first and the second optical components comprises a waveguide of a photonic integrated circuit.

In an embodiment which may be in accordance with any of the previous embodiments, at least the coupling waveguide of the glass coupler body of the first optical coupling element and/or the second coupling waveguide is configured to adjust a mode field shape of light propagating therein.

In an embodiment which may be in accordance with any of the previous embodiments, the coupling waveguide of the glass coupler body of the first optical coupling element and/or the second coupling waveguide is configured to rotate polarization of light propagating therein.

In an embodiment which may be in accordance with any of the previous embodiments of the first alternative,
the first optical component and the second optical component comprise arrays of pluralities of transmitting and receiving facets, respectively;
the glass coupler body comprises an array of a plurality of converging members and a plurality of coupling waveguides between the converging members and output facets on the transmitting side surface facing and being aligned with the receiving facets.

In an embodiment in accordance with the previous embodiment, the coupling waveguides of the plurality of coupling waveguides are in accordance with the preceding embodiment with each of the coupling waveguides comprising an input waveguide part, an intermediate waveguide part, and an output waveguide part, the intermediate waveguide parts of at least two coupling waveguides lying in a light coupling connection with each other.

In another embodiment which may be in accordance with any of the previous embodiments of the second alternative,
the first optical component comprises an array of a plurality of transmitting facets, and the optical coupling arrangement comprises at least one second optical component comprising a plurality of receiving facets, and at least one second glass coupler body;
the glass coupler body of the first optical coupling element comprises an array of a plurality of converging members and a plurality of coupling waveguides between the converging members and a plurality of output facets on the transmitting side surface;
the at least one second glass coupler body comprises a plurality of second input facets on the second receiving side surface(s) thereof, and a plurality of second coupling waveguides between the second input facets and a plurality of second output facets on the second transmitting side surface (s) thereof, the second output facets and the receiving facets facing each other mutually misaligned by second coupler misalignments; and
the optical coupling arrangement comprises a plurality of optical fibers connected to, and optically coupling, the output facets of the glass coupler body of the first optical coupling element and the second input facets.

In an embodiment in accordance with the previous embodiment, the optical coupling arrangement comprises at least two second glass coupler bodies each comprising at least one of the plurality of second coupling waveguides, and at least two second optical components each comprising at least one of the plurality of receiving facets.

In an embodiment in accordance with any of the two previous embodiments, at least two passive optical fibers of the plurality of passive optical fibers are incorporated within an optical fiber cable, such as an optical fiber ribbon cable.

In a third aspect, an optical transceiver is disclosed, comprising an optical coupling arrangement in accordance with the second aspect or any embodiment thereof.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in view of the accompanying drawings, wherein:

FIGS. 1a and 1b, show side and top views, respectively, of an optical coupling element and an optical coupling arrangement comprising the same;

FIG. 1c shows a side view of the optical coupling element of FIGS. 1a and 1b;

FIG. 2 shows a top view of an optical coupling element and an optical coupling arrangement comprising the same;

FIG. 3 shows details of an optical coupling element and an optical coupling arrangement; and

FIGS. 4 to 10 show further optical coupling elements and optical coupling arrangements comprising the same.

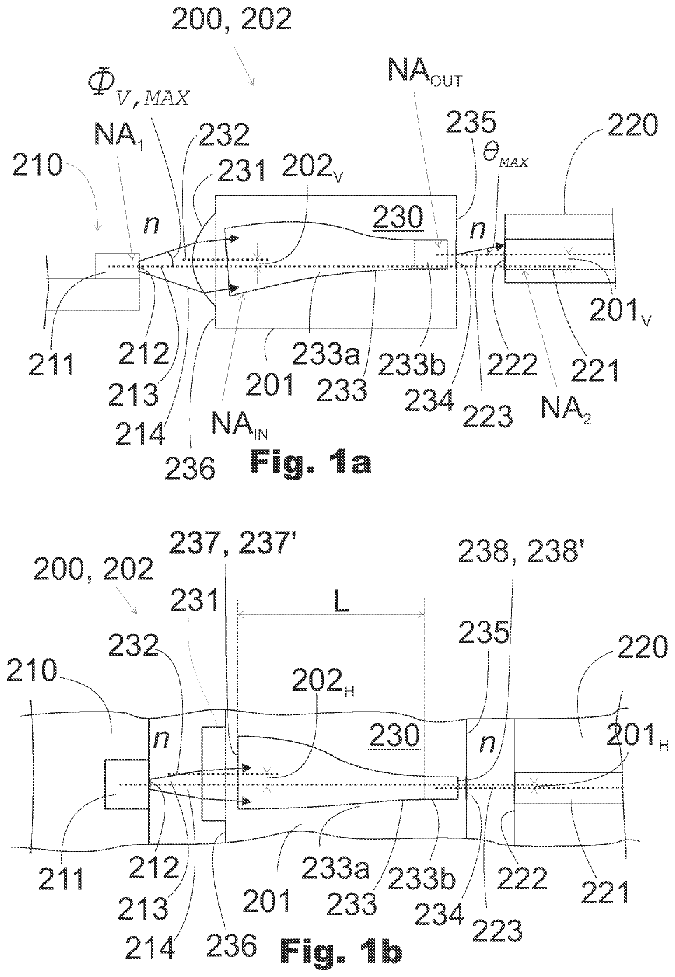

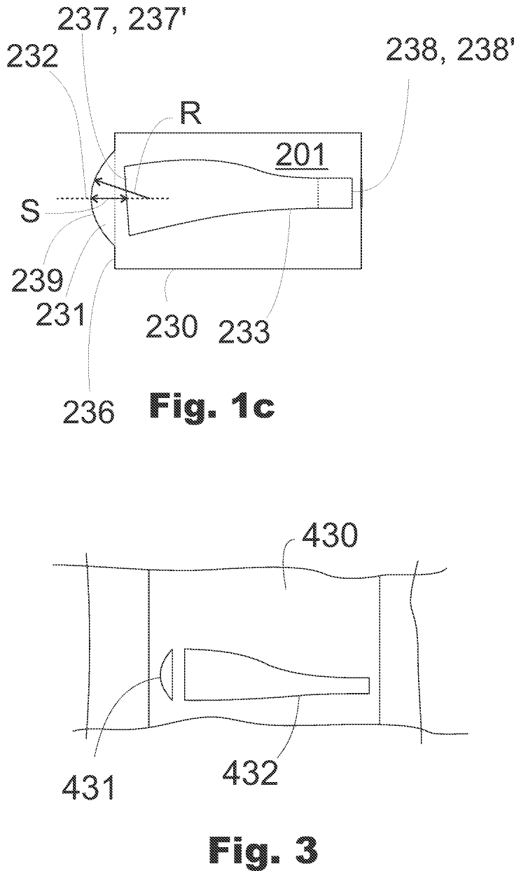

The drawings of FIGS. 1a, 1b, 1c, and 2 to 10 are schematic illustrations of three-dimensional entities. They are not drawn to scale.

### DETAILED DESCRIPTION

The detailed description provided below in connection with the appended drawings is intended as a description of a number of embodiments and is not intended to represent the only forms in which the embodiments may be constructed, implemented, or utilized.

One or more of the embodiments specified above and/or hereinafter may advantageously provide a high-efficiency optical coupling arrangement between optical components where different numerical apertures, different optical mode field properties, and/or different facet properties such as size and shape of the facets of the opposite optical components are matched. Further, it may be possible to form the optical coupling arrangement so as to have effect of various assembling misalignment(s) compensated. The optical coupling arrangement may be manufactured using passive alignment of the optical components.

“Optical coupling” between two optical components refers to the possibility of an optical signal passing, or being transmitted, between the two optical components. Thus, two optical components being optically coupled refers to an optical signal path being formed between the two optical components. Such optical signal path may comprise sections in various materials such as in solid optical material(s) and in the air.

An optical coupling arrangement may refer to the two optical components and possible one or more other components, parts, and/or elements, such as one or more optical coupling elements, being arranged in a specific positional and/or functional relationship to each other. An optical coupling arrangement may form at least part of an optical coupling assembly or an optical coupling device.

From a terminological point of view, such an optical coupling arrangement, assembly, or device may form an optical interconnection configured to optically interconnect the two optical components.

Numerical aperture matching may refer to the optical coupling arrangement being suitable for optically coupling two optical components with different numerical apertures, or other parameter(s) corresponding to numerical aperture(s), with limited optical losses caused by the numerical aperture difference.

Optical mode field matching may refer to the optical coupling arrangement being suitable for optically coupling two optical components with different optical mode field properties, such as a mode field shape or size, with limited optical losses caused by the optical mode field parameter difference(s).

An optical coupling arrangement or assembly may be used, for example, to form a laser-to-PIC coupling for optical data communication. In other embodiments, an optical coupling arrangement or assembly may be used in any other appropriate application or device, especially for optical data communication or transfer or optical sensing, where optical coupling or interconnection between two optical components is needed.

Hereinafter, optical coupling elements and optical coupling arrangements are discussed with reference to FIGS. 1a, 1b, 1c, and 2 to 10.

In such optical coupling arrangements, the first and second optical components may be any appropriate optical components capable of transmitting and receiving light, respectively. One or both of them may comprise an optical component designed to form, or to be used in connection with, a photonic integrated circuit or an optical fiber.

The first optical component may comprise an active optical component or element such as a semiconductor laser, an optical amplifier, or an optical modulator.

The second optical component may comprise, for example, a photonic integrated circuit having an optical waveguide, or an optical fiber. Such optical waveguide or an optical fiber may be a part of, or be connected to, for example, an optical modulator, an optical detector, or any other appropriate type of optical component or element.

In an example embodiment where certain advantages may be achieved, the first optical component comprises a semiconductor laser and the second optical component comprises a waveguide of a photonic integrated circuit.

The first optical component has a transmitting facet.

A “facet” refers to a transmitting or receiving area on a surface for transmitting or receiving light, respectively. For example, in the case of a semiconductor laser, a transmitting facet may refer to the light emitting area on the laser outer surface. In the case of a waveguide or an optical fiber, a transmitting or receiving facet may refer to the transmitting or receiving area, respectively, at the end of the waveguide or the optical fiber.

The first optical component is configured to transmit a light beam out of the transmitting facet with a beam divergence which corresponds to a first numerical aperture.

The beam divergence may refer to a far field half angle of the edge of the light beam relative to the optical axis of the optical component or the beam axis of light beam transmitted by it. In the case of a gaussian light beam, the edge of the light beam may be defined as the point with an intensity of 1/e² times the maximum intensity on the beam axis.

A light beam may have an asymmetric beam shape or mode field shape with different beam divergences in different directions perpendicular to each other. This may be the case, for example, with some active optical components such as semiconductor lasers or optical amplifiers. In the case of an asymmetric beam or mode shape, the beam divergence may be, for example, as high as 40 to 50 degrees in one direction such as a vertical or horizontal direction. In a perpendicular direction, such as a horizontal or vertical direction, respectively, the beam divergence may be, for example, as low as less than or equal to 10 or 15 degrees.

In the case of a light beam with different beam divergencies, the beam divergence discussed hereinafter may refer to the maximum beam divergence.

The second optical component has a receiving facet and is configured to receive light via the receiving facet with a second numerical aperture which may be smaller than the first numerical aperture.

As known in the art, a numerical aperture NA may be defined as the sine of the maximum half angle θₘₐₓ of the acceptance of an optical component or element: NA=n·Sin θₘₐₓ, where n is the refractive index of the medium outside the optical component or element where the light propagates. Light incident on a receiving facet with a higher angle of incidence relative to the optical axis of the optical component or element cannot enter the optical component or element. Thereby, a numerical aperture of an optical component or element is related to and specifies a maximum angle of incidence of light that can enter an optical component or element, such as an optical waveguide or an optical fiber. Correspondingly, that same maximum angle of incidence may also be the maximum angle into which light can exit from such optical component or element.

A beam divergence “corresponding to” a specific numerical aperture refers to the beam divergence being the same as the maximum angle of incidence specified by the numerical aperture in question. Thus, the transmitted light beam with a beam divergence corresponding to the first numerical aperture higher than the second numerical aperture results in the beam divergence angle exceeding the maximum angle of incidence with which light can enter the second optical component.

The first optical component such as a semiconductor laser being configured to transmit a light beam with a beam divergence corresponding to a first numerical aperture may refer to such component having the first numerical aperture.

In the case of the first optical component being, for example, a waveguide having a first numerical aperture, the beam divergence of the light beam transmitted out of the first optical component through the transmitting facet is in accordance with the first numerical aperture.

The difference between the first and the second numerical apertures means that optical losses would inevitably occur when directing the transmitted light beam from the first optical component directly to the second optical component.

An optical coupling arrangement to optically couple the first and the second optical component comprises an optical coupling element, which may be called or considered as a first optical coupling element. Such optical coupling element comprises a glass coupler body, which may be called or considered as a first glass coupler body.

The glass coupler body is formed of a glass material. It has a receiving side surface and an opposite transmitting side surface, and a converging member. The converging member is configured to reduce, in accordance with converging characteristics, divergence of light such as light of the light beam entering the glass coupler body via the receiving side surface.

“Converging” refers in this specification to reducing divergence of light. A converging member may serve as a collimating member, “collimating” referring to the reduction of divergence. However, after converging, the light can still have some divergence. Respectively, after collimating, the light does not need to be completely collimated.

The receiving side surface may serve as, or be called, a “receiving face” of the glass coupler body. Respectively, the transmitting side surface may serve as, or be called, a “transmitting face” of the glass coupler body.

To be able to converge the light entering the glass coupler body, the converging member may be arranged on, at, or in proximity of the receiving side surface.

The converging member being configured to reduce the divergence of the light beam may refer to the converging characteristics thereof being selected so as to be able to specifically reduce the divergence of the light beam of the first optical component. Thereby, a converging member with optimized converging characteristics may be used in the coupling arrangement.

The glass material may comprise any appropriate glass with sufficiently high optical transparency and sufficiently low optical losses for optical coupling arrangements for data communication. Also, sufficient thermal stability is advantageous for applications where optical interconnections are exposed to elevated temperatures. Possible glass materials include, for example, soda lime glass, silicate glass, silica glass, borosilicate glass, and silicon nitride.

The three optical elements in the form of the first and the second optical components and the glass coupler body may be positioned so as to lie on any appropriate carrier or substrate. An optical element may be attached to such carrier or substrate, for example, by an adhesive or by some mechanical attaching or mounting means. A substrate or carrier may comprise, or be formed as, a printed circuit board PCB.

In an embodiment, the optical components and the glass coupler body are positioned such that:
the glass coupler body lies between the first and the second optical components;
the transmitting and receiving facets of the optical components face each other and are mutually misaligned by an optical component misalignment; and
the converging member and the transmitting facet face each other and are mutually misaligned by a coupler misalignment.

A “mutual misalignment” refers to the mutual positioning of two elements deviating from a complete mutual alignment.

Mutual alignment may be determined by means of principal axes associated with the transmitting facets and receiving facets and the converging member. Depending on the type and operational principle of an optical component or element, a principal axis may refer to, or be formed by, an optical axis of the optical component or element.

In complete mutual alignment, the principal axes of two optical elements or components coincide such that they are parallel, i.e. identically oriented, and positioned on top of each other. Then, each of the two optical elements or components may be considered having its facet aligned with the facet of the other optical element or component.

In positioning the first and the second optical components and the glass coupler body, the objective may be a complete mutual alignment between the transmitting and receiving facets, and/or between the transmitting facet and the converging member. However, in practice, complete mutual alignment is not achievable, but some mutual misalignment always occurs after the positioning of two optical components or elements. It may result from the positioning inaccuracy of the positioning apparatus or system used for the positioning.

A translational misalignment occurs if the principal axes of two optical components or elements are parallel but there is an offset between them in a plane perpendicular to at least one of the principal axes.

An orientational misalignment occurs when the principal axes are not parallel, but there is a non-zero angle between them.

The mutual misalignment between the transmitting and receiving facets of the first and the second optical components, respectively, is named here “an optical component misalignment”.

Correspondingly, the mutual misalignment between the transmitting facet and the converging member of the first optical component and the glass coupler body, respectively, is named here “a coupler misalignment”. Each of those alignments may be called “an assembling misalignment” or “a misalignment”.

In addition to losses caused by different numerical apertures of the two optical components (or the beam divergence and the second numerical aperture), also mutual misalignment(s) between the optical components may result in optical losses in comparison to a situation with complete mutual alignment.

Further optical losses may be caused, for example, due to mode field of the first optical component or the light beam incident on the transmitting facet having a size and/or shape differing from the size and/or shape, respectively, of the mode field of light propagating in the second optical components.

In the optical coupling element, a coupling waveguide extends within the glass coupler body between the converging member and an output facet on the transmitting side surface. In the complete optical coupling arrangement, the output facet faces and is aligned with the receiving facet of the second optical component.

The coupling waveguide is configured to transmit light received and at least partially converged by the converging member through the glass coupler body to the output facet. In a complete optical coupling arrangement, it may be used to optically couple, with a coupling efficiency, the first and the second optical components by transmitting light of the light beam to the output facet and further to the receiving facet.

Then, the coupling waveguide is configured to reduce effect(s) of the misalignments, possible difference between the first and the second numerical apertures, and/or the converging characteristics on the coupling efficiency.

Being configured to reduce such effect(s) may refer to the coupling waveguide having been designed by taking into account in the designing the misalignments, possible difference between the numerical apertures, and/or the converging characteristics of the converging member. Also other parameters and factors may be taken into account in the designing.

To implement such reduction of adverse effects, an optical coupling arrangement may be manufactured, for example, with the following process:
positioning the first and the second optical components opposite to each other;
positioning the optical coupling element between the first and the second optical components,
determining the misalignments;
designing, on the basis of the determined misalignments, the first and the second numerical aperture, and/or the converging characteristics, the coupling waveguide; and
forming at least part of the designed coupling waveguide in the coupler preform body by direct laser writing.

Direct laser writing is a method basically known in the art to accurately and efficiently modify the optical properties, especially the refractive index, of a glass material. In the case of forming the designed coupling waveguide, laser writing may be used to make the refractive index of the volume of the designed coupling waveguide higher than that of the surrounding glass material.

In direct laser writing, a femtosecond laser and two-photon absorption may be utilized. A direct laser writing process may comprise, for example, a sequence of femtosecond laser pulses, performed in optical power range of 100-500 mW, followed by low-temperature cooling periods.

Advantageously, when the coupling waveguide is configured to reduce effect(s) of the misalignments, possible difference between the first and the second numerical apertures, and/or the converging characteristics on the coupling efficiency, the efficiency of light transmission through the glass coupler body may be maximized without any need for active alignment of the optical components and the glass coupler body. Passive alignment may shorten the manufacturing time and costs of the optical coupling arrangement.

“Active alignment” refers to positioning the optical components to be coupled while the optical components being operative, with at least one of them transmitting light, and actively adjusting the alignment on the basis of light signal passed through the coupling.

Advantageously, the optical coupling element and the optical coupling arrangement may enable providing a high efficiency optical coupling arrangement for coupling two optical components with different numerical apertures. This may be at least partially achievable by the use of the converging element, i.e. the converging member, of the glass coupler body. The coupler may thereby serve for matching the first and the second numerical apertures.

Some active optical components may have higher numerical apertures than passive optical components. For example, for an active optical component, the numerical aperture may be, for example, higher than or equal to 0.2. For some components, numerical apertures such as higher than or equal to 0.3 are possible. For a passive optical component, instead, the numerical aperture may be, for example, less than or equal to 0.1.

The optical coupling arrangement disclosed herein may provide specific advantages in embodiments where the first optical component is an active optical component with a high first numerical aperture, such as a semiconductor laser or an optical amplifier, and the second optical component is an optical component with a substantially lower second numerical aperture.

Yet further decrease in optical losses may be achievable by having the coupling waveguide configured so that it matches at least partially also other properties of the first and the second optical components than the first and the second numerical apertures.

For example, the coupling waveguide may be designed and formed to adjust a mode or beam shape of light propagating in the coupling waveguide. Thereby, an optical coupling arrangement or an optical coupling element may be configured to match the mode or beam shapes of the first and the second optical components.

As another example of further functionalities of the optical coupling arrangement or optical coupler, the coupling waveguide may be designed to rotate polarization of light propagating therein. Thereby, an optical coupling arrangement or an optical coupling element may be configured to match the polarization properties of the first and the second optical components.

The functionalities discussed above may be multiplied in optical coupling elements and optical coupling arrangements having pluralities of optical components and/or elements arranged in arrays. In such embodiments, the first optical component may comprise an array of transmitting facets, the second optical component may comprise an array of receiving facets, and the glass coupler body may comprise an array of converging members. In some embodiments, an array of converging members may be formed by one elongated integrated element such as a cylindrical lens, different sections thereof serving as a plurality of converging members. An example is shown in FIG. 6 where one elongated elliptical cylindrical lens 731 serves as, or forms, an array of a plurality of converging members. Thus, the plurality of converging members, marked in the drawing of FIG. 6 by dashed lines, forms a single integral lens structure.

A converging member may comprise, for example, a lens, such as an elliptical lens, for example, an elliptical cylindrical lens. Such lens may form a local extension outwards of the receiving side surface.

“Elliptical” refers to a generally elliptical surface, also covering a spherical surface as a special case of ellipticity.

In other embodiments, a lens may be formed within the glass coupler body. Such lens may be formed in the operation of providing the glass coupler body by direct laser writing.

Examples of lenses serving as converging members are disclosed hereinafter with reference to FIGS. 1a, 1b, 1c, and 2 to 10.

In the following, embodiments of the optical coupling element and optical coupling arrangement are discussed further with reference to FIGS. 1a, 1b, 1c, and 2 to 10.

The optical coupling arrangement 200 of FIGS. 1a, 1b, and 1c may form a part of an optical transceiver 202. In other embodiments, optical coupling arrangements may be used in, or form a part of, other devices or apparatuses.

The optical coupling arrangement comprises a first optical component 210 comprising a semiconductor laser 211, a photonic integrated circuit 220 comprising an optical waveguide 221, serving as a second optical component, and an optical coupling element 201 comprising a glass coupler body 230 made of a glass material.

Hereinafter, a photonic integrated circuit may be referred to as a “PIC”.

A transmitting facet 212 of the semiconductor laser 211 and a receiving facet 222 of the PIC 220 face each other, and an elliptical cylindrical lens 231 on a receiving side surface 236 of the glass coupler body 230 faces the transmitting facet 212. A coupling waveguide 233 has been formed in the glass coupler body 230 between the elliptical cylindrical lens 231 and an output facet 234 at a transmitting side surface 235 of the glass coupler body 230.

The glass coupler body 230 may be a plate-form construction, the plate extending substantially along a fictitious base plane. Such base plane may define horizontal directions. The receiving and transmitting side surfaces thereof may extend perpendicularly relative to such base plane, thus vertically. Those side surfaces may be parallel to each other.

At least a part of the coupling waveguide 233 may have been formed by direct laser writing.

The optical components and the optical coupling element may have been positioned in accordance with predetermined mutual positionings determined as the opposite optical components or elements facing each other with complete alignment. However, in practice, positioning accuracy may have been incomplete, resulting in misalignments.

This is illustrated in FIG. 1a by offsets between the principal axes of the three components. A vertical offset between the optical axis 213 of the semiconductor laser 211 and the optical axis 223 of the optical waveguide 221 of the PIC 220 forms an optical component vertical misalignment 201v. A vertical offset between the optical axis 232 of the cylindrical lens 231 and the optical axis 213 of the semiconductor laser 211 forms a coupler vertical misalignment 202v. The coupler vertical misalignment 202v may be, for example, less than or equal to 2 μm.

In the side view drawing of FIG. 1a, only vertical misalignments are visible. Also horizontal misalignment(s) exist as illustrated in FIG. 1b. A horizontal offset between the optical axis 213 of the semiconductor laser 211 and the optical axis 223 of the optical waveguide 221 of the PIC 220 forms an optical component horizontal misalignment 201_{H}. A horizontal offset between the optical axis 232 of the cylindrical lens 231 and the optical axis 213 of the semiconductor laser 211 forms a coupler horizontal misalignment 202_{H}. The coupler horizontal misalignment 202_{H} may be, for example, less than or equal to 1 μm.

In general, a misalignment may be two dimensional, comprising an offset in two perpendicular directions such as horizontal and vertical.

In the example of FIGS. 1a, 1b and 1c, the misalignments comprise offsets of the principal axes only. In other embodiments, one or more misalignments may comprise, in addition to or instead of an offset, an orientational misalignment.

In the example of FIGS. 1a, 1b, and 1c, the semiconductor laser 211 is an edge emitting laser. In other embodiments, for example, vertical cavity surface emitting lasers VCSELs may be used.

The semiconductor laser 211 is an example of an active optical component or element. In other embodiments, first optical components may comprise other types of active optical element such as optical amplifiers or optical modulators. In yet other embodiments, a first optical component may comprise a passive optical element such as a passive optical waveguide.

The semiconductor laser 211 and the waveguide 221 of the PIC 220 may be the only optical elements of the first and the second optical components of the optical coupling arrangement 200. Alternatively, they may represent single elements of an array or semiconductor lasers, and an array of waveguides, respectively.

The semiconductor laser 211 is configured to transmit, when in use, a light beam 214 marked by arrows in the drawings of FIGS. 1a and 1b. The light beam has a vertical beam divergence with a far field maximum half angle Φ_{V,MAX}. The beam divergence thus corresponds to the maximum divergence of light output or transmitted from an optical element or component facet having a first numerical aperture NA₁=n·Sin Φ_{V,MAX}. Thereby, the beam divergence corresponds to such first numerical aperture.

The receiving facet 222 of the waveguide 221 of the PIC 220 has a second numerical aperture NA₂ defining a maximum half angle θ_{MAX} of light capable of entering the waveguide via an equation: NA₂=n·Sin θ_{MAX}.

The vertical maximum half angle Φ_{V,MAX} of the light beam 214 is larger than the maximum half angle θ_{MAX} of light capable of entering the waveguide 221. The second numerical aperture is thereby smaller than the first numerical aperture. Therefore, in the case of direct coupling between the semiconductor laser 211 and the waveguide 221, high optical losses could occur as only part of the light emitted or transmitted by the semiconductor laser 211 could enter the waveguide 221.

The elliptical cylindrical lens 231 may serve as a converging member for converging, with the optical coupling arrangement 200 in use, divergent light incident on the elliptical cylindrical lens 231. Thereby, with the optical coupling arrangement 200 in use, the elliptical cylindrical lens as a converging member may serve for matching the first and the second numerical apertures.

A converging member such as a lens, for example, the elliptical cylindrical lens 231, may be considered as a numerical aperture adjustment element serving for the numerical aperture matching.

The converging characteristics of the elliptical cylindrical lens 231 of FIG. 1 may have been selected for converging specifically the light beam 214 of the semiconductor laser 211.

In addition to serving for matching the numerical apertures, the elliptical cylindrical lens 231 may change the shape of the light beam 214 beam. This may be at least partly achieved by the elliptical cylindrical lens 231 converging the light beam in one direction only, namely, in the vertical direction. Semiconductor lasers may have an asymmetric beam or mode field shape with different beam divergencies in horizontal and vertical directions. Thereby, a converging member converging the beam or mode field shape in this direction may make the light beam or mode field shape more symmetric.

In the example of FIGS. 1a, 1b, and 1c, the semiconductor laser has its highest divergence in the vertical direction.

In other embodiments, an optical element such as a semiconductor laser may have an asymmetric beam or mode field shape with the highest divergence in the horizontal direction. Then, an elliptical cylindrical lens may be arranged on or in the glass coupler body in a position perpendicular to the position of the elliptical cylindrical lens 231 of FIGS. 1a, 1b and 1c. In yet other embodiments, an optical element such as a semiconductor laser may have a symmetric beam or mode field shape.

The coupling waveguide 233 has at its first end 237, i.e. the end at the side of the receiving side surface 236 of the glass coupler body 230, an input numerical aperture NAᵢₙ. Due to the converging effect of the elliptical cylindrical lens 231, the input numerical aperture NAᵢₙ may be smaller than the first numerical aperture NA₁.

The coupling waveguide 233 is curved. As illustrated in the side and top view drawings of FIGS. 1a and 1b, there is curvature in both horizontal and vertical directions. Thereby there is a three-dimensional curvature. Then, observed in a cross-sectional plane on the glass coupler body, the locations of the ends of the coupling waveguide may differ both in the horizontal and vertical directions. Thereby, the coupling waveguide may be inclined. The coupling waveguide 233 also narrows towards the output facet 234.

“Narrowing” refers to a width, or cross-sectional area, of the coupling waveguide decreasing. Thereby, the coupling waveguide becomes, in its cross-section direction perpendicular to the longitudinal direction thereof, smaller. Narrowing “towards the output facet” refers to the coupling waveguide having at least one such position along its longitudinal direction at which position the width or cross-sectional area thereof is smaller than the width or cross-sectional area at another position which lies closer to the receiving side surface than the first mentioned position.

Narrowing of the coupling waveguide may be constant, i.e. occur with a constant rate such that the change of the width or cross-sectional area per a length unit remains the same. Alternatively, the narrowing may be changing, i.e. occur with different rates such that the change of the width or cross-sectional area per a length unit is different at different positions along the longitudinal direction of the waveguide. The changing may be continuous such that said rate changes continuously along the longitudinal direction.

Curved shape and/or narrowed configuration of coupling waveguide may affect the mode field or beam of light propagating therein in various aspects. For example, a curved configuration may be designed to compensate the optical component misalignment and/or the coupler misalignment. Thereby, efficient optical coupling between the first and the second optical components may be achieved.

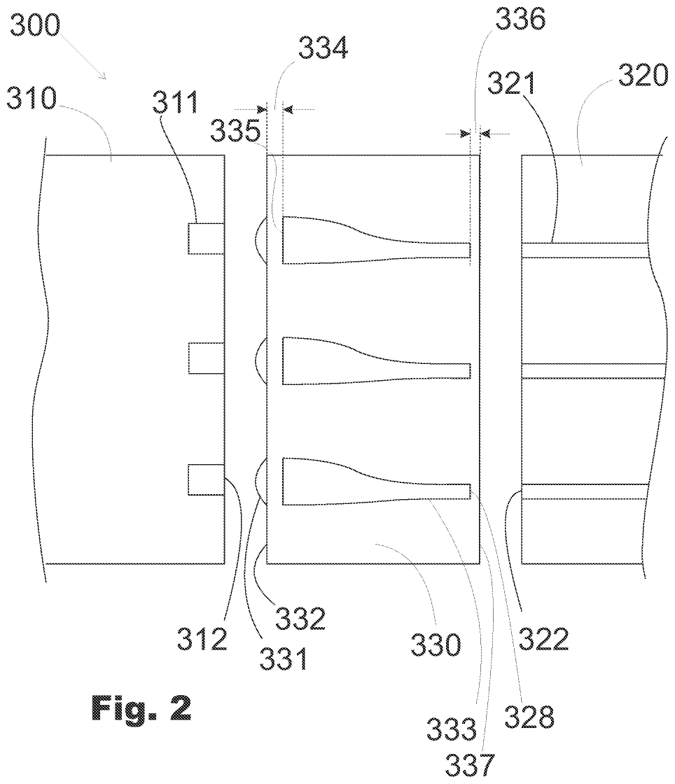

The coupling waveguide 233 of FIG. 2 has a narrowing and curved beam adjusting section 233a followed by a non-narrowing straight waveguide section 233b. Non-narrowing refers to the straight waveguide section having substantially constant cross-sectional area or width. The properties of the beam adjusting section 233a may have been designed so as to gradually lower the numerical aperture of the coupling waveguide. Thereby, the numerical aperture matching between the first and the second optical components may be carried out partly by the converging member and the coupling waveguide.

The beam adjusting section has, in a longitudinal direction of the glass coupler body extending between the receiving side surface and the transmitting side surface, a length L. It may be, for example, less than or equal to 200 μm, for example, between 100 and 200 μm.

Due to the decrease of the cross-section of the coupling waveguide in result of the narrowing of the beam adjusting section, the coupling waveguide has at its first end 237 a first facet 237′ larger than a second facet 238′ at its second end 238, i.e. the end at the side of the transmitting side surface 235 of the glass coupler body 230.

The first and the second facets may form an input and output facet, respectively, of the coupling waveguide.

The properties of the beam adjusting section 233a may configured to also adjust the size and/or shape of the mode field of the coupling waveguide so that the light entering the straight waveguide section 233b can be coupled efficiently to the optical waveguide 221 of the PIC 220. Then the coupling waveguide may have at its second end 238 an output numerical aperture NAₒᵤₜ smaller than or equal to the second numerical aperture NA₂, enabling efficient coupling of the light to the second optical component through the receiving facet.

The straight waveguide section 233b may be prefabricated so as to exist in glass coupler preform body. Then, the rest part of the designed coupling waveguide, namely, the beam adjusting waveguide section 233a, may formed by direct laser writing.

Curvature parameters of the coupling waveguide may have been chosen so as to provide adiabatic light propagation resulting in minimal losses via leakage of light out of the coupling waveguide.

FIG. 1c shows a side view of the optical coupling element 201 of FIGS. 1a and 1b. The elliptical cylindrical lens 231 as the converging member has a receiving interface 239 at the optical axis 232 thereof.

“Receiving interface” refers to the surface via which the converging member receives light, i.e. via which the light enters the lens.

The receiving interface 239 has, at the location of the optical axis 232, a radius of curvature R. The elliptical cylindrical lens 231 lying on the receiving side surface 236 of the glass coupler body 230 is dimensioned such that the receiving interface 239 lies at a converging member separation distance of 0.5 to 1.5 R, as defined along the optical axis 232 of the lens, from the receiving interface. The converging member separation distance S may be, for example, about 0.7 R, 1.0 R, or 1.3 R.

Such converging member separation distance may enable the light from the converging member to be transmitted to the coupling waveguide with a high efficiency, i.e. with low coupling losses.

As illustrated in FIGS. 1a and 1c, the first facet 237′ is slightly tilted, i.e. lies at an angle, relative to the receiving side surface 236. Such non-parallel direction of the first facet may serve for compensating adverse effects caused by non-zero coupler misalignment.

In other embodiments, a first facet may be parallel to the receiving side surface.

The optical coupling arrangement 300 of FIG. 2 represents an array-based implementation of the optical coupling arrangement and the optical coupling element thereof.

In the optical coupling arrangement 300, both the first optical component and the second optical component comprise an array of optical elements.

The first optical component 310 comprises an array of semiconductor lasers 311, from which light is output through a transmitting facet 312. The second optical component is a second PIC 320 comprising an array of input waveguides 321 receiving light via receiving facets 322. The input waveguides may be optically coupled to further optical elements or components, for example, optical modulators, optical detectors, or optical amplifiers.

Correspondingly, the glass coupler body 330 has an array of converging members in the form of lenses 331 on its receiving side surface 332.

Light output from the semiconductor lasers 311 may in this example have a substantially symmetric mode field or beam shape. Then, differently from the elliptical cylindrical lens 231 of FIG. 2 example, the lenses 331 may have rotational symmetry. They may be, for example, rotationally symmetric elliptical lenses such as spherical lenses.

The semiconductor laser, the second PICs and the glass coupler body are positioned such that the semiconductor lasers 311, input waveguides 321, and lenses 331 form groups of three elements. For each semiconductor laser 311 with a transmitting facet 312, there is an opposite input waveguide 321 with a receiving facet 322 as well as a lens 331 facing the transmitting facet.

The distances between adjacent converging members may be arranged to be equal to the distances between corresponding adjacent transmitting facets 312 of the semiconductor lasers. In the example of FIG. 2, the distances between the semiconductor lasers and those between the input waveguides are identical. Then, also the lenses have been arranged onto the glass coupler body with the same distances therebetween.

The distances between adjacent elements in the arrays may be, for example, in the range of 100 to 2500 μm.

For each group of a first optical component, a converging member, a coupling waveguide, and a second optical component, details and operation of the coupling arrangement 300 may be in accordance with any of the embodiments discussed above with reference to FIGS. 1a, 1b, and 1c.

The identical distances result in equal assembling misalignments in each group of elements. Then, also the designed coupling waveguides of different groups of elements may be mutually identical.

The lenses of the examples of FIGS. 1a, 1b, 1c, and 2 have one continuous surface section as a refractive interface of the lens. In other embodiments, flat lens configuration may be used where, instead of one single elliptical surface section, the lens has a plurality of elliptical surface sections connected via connecting surface sections extending substantially parallel to the optical axis of the flat lens. The principle is known from Fresnel type lenses. Such flat lens configuration can me made thin, which may enable the glass coupler body to be positioned close to the first optical component.

The lens types discussed above with reference to FIGS. 1a, 1b, 1c, and 2 are examples of converging members forming local extensions of the glass coupler body out of the receiving side surface thereof. Such lenses may be incorporated in a glass coupler body as separate elements mounted on an initially flat receiving side surface. Such mounting may be done, for example, by glass bonding or by using an optically clear adhesive. In other embodiments, a converging member such as a lens may be an integral part of the glass coupler body without any material interface between the converging member and the rest of the glass body. For example, a coupler preform may be molded as directly having the outwards extending converging members thereon. Those two alternatives are illustrated in FIGS. 1a, 1b, 1c, and 2 by the receiving side surface 236 at the location of the converging member 232 being marked by a dashed line.

In the examples of FIGS. 1a, 1b, 1c, and 2, the coupling waveguides have their ends separated from the receiving side surfaces and the transmitting side surfaces by edge separation distances. As marked in FIG. 2, a first edge separation distance 334 exists between the receiving side surface 332 of the glass coupler body 330 and first ends 335 of the coupling waveguides 333 at the side of the receiving side surface. A second edge separation distance 336 exists between the transmitting side surface 337 of the glass coupler body 330 and second ends 338 of the coupling waveguides 333 at the side of the transmitting side surface. The dimensions and effects of the edge separation distances are discussed above with reference to FIG. 1.

With an end of the coupling waveguide lying at an edge separation distance from the associated side surface of the glass coupler body, advantages may be achieved when forming the coupling waveguide by direct laser writing in avoiding adverse effects possibly occurring if carrying out the direct laser writing up to an edge of the glass coupler body. The edge separation distance may be, for example, in the range of 2 to 25 μm. For example, it may be about 2, 5, 10, 15, 20, or 25 μm.

FIG. 3 illustrates a different lens configuration where an integral lens 431 is formed within the glass coupler body 430. The integral lens 431 forms within the glass coupler body a volume having a refractive index higher than that of the surrounding material.

The integral lens may have been formed by direct laser writing using a laser beam. This may advantageously enable efficient use of the same laser for both forming the converging member(s) and the coupling waveguide(s) 432.

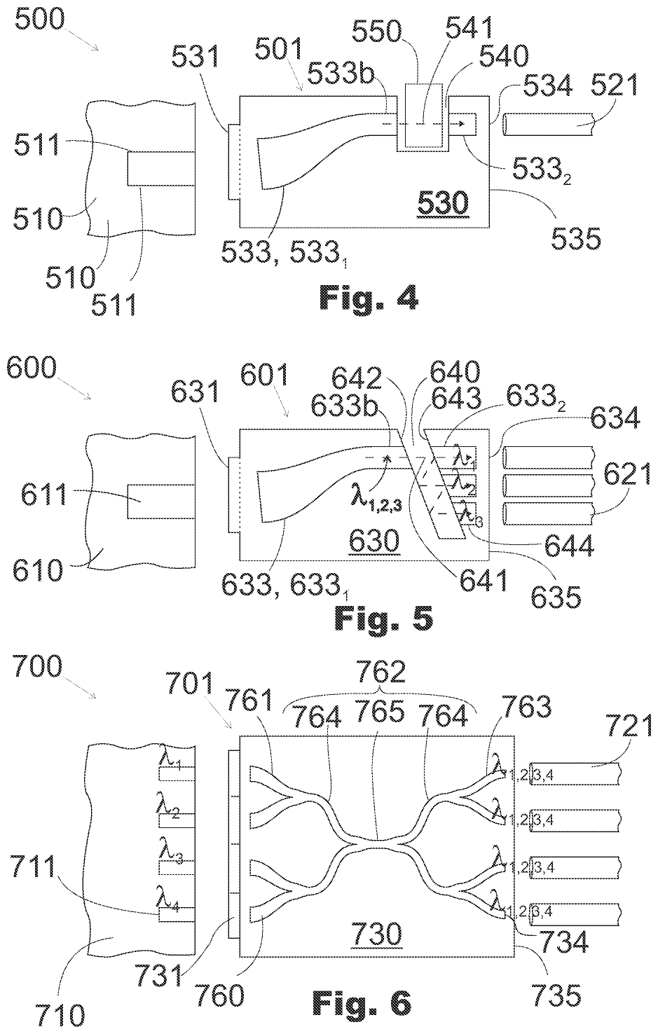

If not otherwise stated, the optical coupling arrangements 500, 600 of FIGS. 4 and 5 and the parts and details thereof may be in accordance with any of the embodiments discussed above with reference to FIGS. 1a, 1b, and 1c. They distinguish from those in that the glass coupler body 530, 630 of the optical coupling element 501, 601 has a cavity 540, 640 therein.

A “cavity” refers to a volume within the glass coupler body in which volume the glass coupler body material is missing. The cavity divides the coupling waveguide 533,633 into a first waveguide part 533₁, 633₁ between the cavity 540, 640 and the converging member 531, 531, and a second waveguide part 533₂, 633₂ between the cavity 540, 640 and the transmitting face 535, 635. In the examples of FIGS. 4 and 5, the coupling waveguide thereby comprises two distinct parts. The two-part coupling waveguide 533, 633 defines an optical path 541, 641 which runs across the cavity 540, 640.

The first and the second waveguide parts are aligned relative to each other so as to allow a light signal received into the cavity 540, 640 from the first waveguide part 533₁, 533₁ to enter the second waveguide part 533₂, 633₂. Thereby, the coupling waveguide 533, 633, although being divided into two parts by the cavity, is configured to transmit light from the converging member 531, 631 to the output facet 534, 634.

In the example of FIG. 4, an optical isolator 550 is positioned in the cavity 540. The optical isolator serves as an intermediate optical component positioned on the optical path defined by the coupling waveguide. The optical isolator 550 may prevent light propagation backwards from the output facet 534 to the converging member 531.

In other embodiments, other intermediate optical components may be positioned in the cavity to carry out other optical functionalities.

In the optical coupling arrangement 600 of FIG. 5, the cavity 640 has two opposite reflective surfaces 642, 643 lying tilted relative to the coupling waveguide.

Being thereby tilted refers to the reflective surfaces lying not parallel nor perpendicular to, but at an inclined angle, to the direction of the optical path 641 in the cavity 640.

The reflective surface 642 at the side of the first waveguide part 633₁ may be, outside the location thereon via which the light enters the cavity, highly reflective. The reflective surface 643 at the side of the second waveguide part 633₂ may be partially transmissive.

The opposite reflective surfaces 642, 643 may form, or serve as, a virtually imaged phase array VIPA configured to spatially separate multi-wavelength λ_{1,2,3} light entering the cavity 640 from the first waveguide part 633₁ into a first wavelength component λ₁ transmitted directly through the cavity to the second waveguide part 633₂, and two additional wavelength components λ₂, λ₃.

The glass coupler body further comprises two additional waveguide parts 644 between the cavity and the transmitting face positioned to receive the two additional wavelength components λ₂, λ₃. In other embodiments, a VIPA may be configured to spatially separate multi-wavelength light entering the cavity into one or into more than two additional wavelength components, and the glass coupler body may comprise a corresponding number of additional waveguide parts.

In the examples of FIGS. 4 and 5, the width and the longitudinal direction of the first waveguide part 533₁, 633₁ and the second waveguide part 533₂, 633₂ at the opposite edges of the cavity 530, 630 are similar. Thus, the cavity 530, 630 may be considered cutting the coupling waveguide 533, 633 at a non-narrowing straight waveguide section 533b, 633b thereof. The cavity may thereby be considered being positioned at the non-narrowing straight waveguide section 533b, 633b. In other embodiments, cavity may be positioned at, or cut the coupling waveguide at, a curved section of the coupling waveguide.

If not otherwise disclosed, the optical coupling arrangement 700 of FIG. 6 may be in accordance with any of the array-based implementations discussed above with reference to FIG. 2.

Like in the example of FIG. 2, the glass coupler body 730 of the optical coupling element 701 of FIG. 6 comprises an array of four converging members 731 and four coupling waveguides 760 between the converging members and output facets 734 on the transmitting side surface 735.

Each of the coupling waveguides 760 comprises an input waveguide part 761, an intermediate waveguide part 762, and an output waveguide part 763. The input and output waveguide parts run in the glass coupler body separate from each other. Instead, the intermediate waveguide parts 762 of different coupling waveguides 760 join together to for joint waveguides as explained below.

In a “joint” waveguide or waveguide part, two or more waveguides or waveguide parts running elsewhere separately, form one single common waveguide or waveguide part.

Observed in the direction from the converging members 731 towards the transmitting side surface 735, first, the input waveguide parts 761 join in pairs to form two double joint waveguides 764. Then, the two thereby formed double joint waveguides 764 join to form a fourfold joint waveguide 765. Thereafter, the fourfold joint waveguide 765 splits in two, forming again two double joint waveguides 764. The double joint waveguides 764 then split in two, resulting in the four separate output waveguide parts 763.

Thereby, the double joint waveguides 764 and the fourfold joint waveguide 765 therebetween are formed by the intermediate waveguide parts 762 of the different coupling waveguides 760.

In a joined waveguide, the intermediate waveguide parts forming the joined waveguide are in a light coupling connection with each other, enabling coupling of light signals between the intermediate waveguide parts.

In other embodiments, instead of forming joint waveguides, intermediate waveguide parts of at least two coupling waveguides may lie in close proximity to each other so as to enable light coupling therebetween. Then, principles of adiabatic coupling or directional coupling, for example, may be used to design the intermediate waveguide parts and the mutual positioning thereof.

Light coupling connection between two or more coupling waveguides may enable splitting light signals of different wavelengths initially propagating in different coupling waveguides. A plurality of split light signals may then be further coupled to propagate in a single coupling waveguide such that after the coupling, each coupling waveguide carries light signals of a plurality of initial wavelengths.

The waveguide parts and joining thereof may be designed so as to achieve low optical losses in the splitting and/or coupling regions of the waveguides. Thereby, highly efficient couplers may be implemented.

In the example of FIG. 6, each of the semiconductor lasers 711 of the first optical component 710 emits light at a specific wavelength λ₁, λ₂, λ₃, λ₄ differing from the wavelength of the other semiconductor lasers. Each input waveguide part 761 receives thus a light signal of one wavelength only. In result of the light coupling between the intermediate waveguide parts 762 of the coupling waveguides 760, light signals of all the wavelengths λ₁, λ₂, λ₃, λ₄ propagate in each of the output waveguide parts 763.

In the example of FIG. 6, the glass coupler body comprises four coupling waveguides forming a 4×4 coupler. In other embodiments, any other appropriate number of coupling waveguides may be used.

The joints of two or more waveguides or waveguide parts may be designed so as to achieve adiabatic coupling of light between the joining waveguides or waveguide parts.

In the example of FIG. 6, the waveguide parts are joined in pairs, and split in two. In other embodiments, waveguide parts may be joined in any appropriate number, and split in any appropriate number.

In the examples illustrated in FIGS. 4 to 6, light from the first optical components 510, 610, 710 comprising semiconductor lasers 511, 611, 711 is coupled to optical fibers 521, 621, 721 serving as, or forming a part of, a second optical component. In other embodiments, the second optical component may comprise, for example, a photonic integrated circuit PIC with an optical waveguide or a plurality of optical waveguides to receive the light.

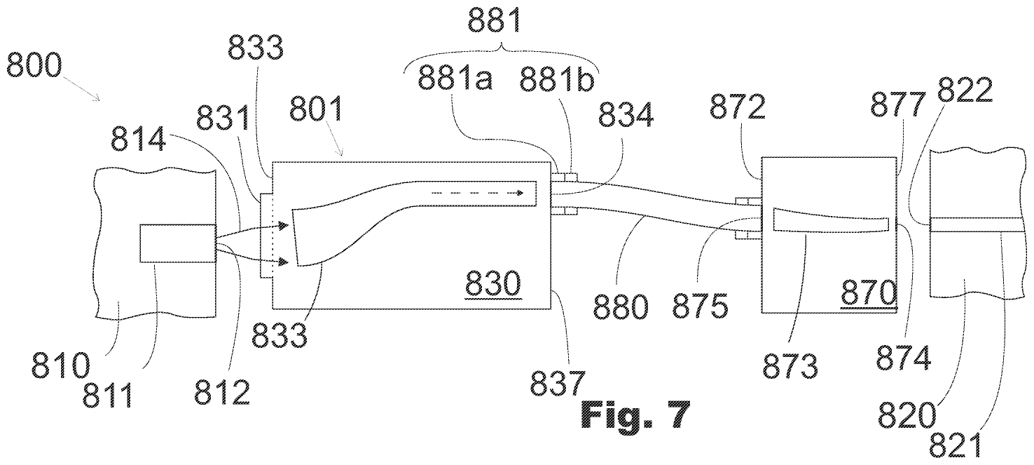

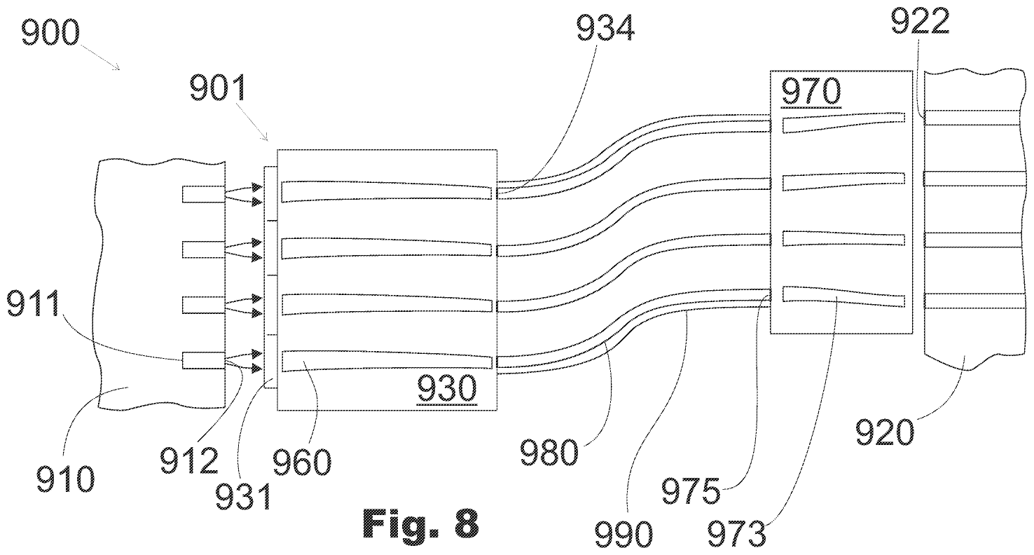

If not otherwise disclosed, the optical coupling arrangement 800 of FIG. 7 may be in accordance with any of the optical coupling arrangements discussed above with reference to FIGS. 1a, 1b, 1c, 2, 3, 4, and 5. It distinguishes therefrom in that there are two sequential glass coupler bodies between the first and the second optical components.

The optical coupling arrangement comprises a first optical coupling element 801 with a first glass coupler body 830. The properties of the first optical coupling element and the first optical glass coupler body thereof may be in accordance with any of the optical coupling elements and the glass coupler bodies discussed above with reference to FIGS. 1a, 1b, 1c, 2, 3, 4, and 5. In the following, the parts and details of the first optical coupling element are referred to using the names of the same parts and details of the optical coupling arrangements discussed above, with a prefix “first” added when appropriate.

The converging member 831 of the first glass coupler body 830 is configured to reduce the beam divergence of the light beam 814 transmitted by the first optical component 810 out of the transmitting facet 812. The first optical component 810 of the example of FIG. 7 comprises a semiconductor laser 811. In other embodiments, the first optical component may comprise, for example, an optical amplifier, or an optical modulator.

The optical coupling arrangement 800 further comprises a second glass coupler body 870 having a second receiving side surface 872 and an opposite second transmitting side surface 877. A second coupling waveguide 873 extends within the second glass coupler body between a second input facet 875 on the second receiving side surface 872 and a second output facet 874 on the second transmitting side surface 877. The second coupling waveguide 873 is configured to transmit light from the second input facet 875 to the second output facet 874. The properties of the second coupling waveguide 873 may be in accordance with any of those coupling waveguides discussed above with reference to any of FIGS. 1a, 1b, 1c, 2, 3, 4, and 5. It may be manufactured similarly to any the coupling waveguides discussed above with reference to FIGS. 1a, 1b, 1c, 2, 3, 4, 5, and 6. For example, direct laser writing may be used to form the second coupling waveguide in the second glass coupler body 870.

The first and the second glass coupler bodies 830, 870 are optically coupled by an optical fiber 880 which is connected to the first output facet 834, i.e. the output facet of the first glass coupler body 830, and the second input facet 875. The optical fiber 880 may be a passive optical fiber. “Passive” may refer to the optical fiber having no amplifier or other active elements manipulating the light propagating therein. The optical fiber may form a part of, or be incorporated within, an optical fiber cable. An optical fiber cable may comprise, for example, a sheath enclosing the optical fiber.

Said coupling and connection refers to the optical fiber enabling transmission of light from the first output facet 834 to the second output facet 874. Thereby, the first and the second glass coupler bodies 830, 870 with the first and the second coupling waveguides 833, 873 serve for forming an optical signal path being between the transmitting facet of the first optical component and the receiving facet of the second optical component.

The optical fiber 880 forming part of such optical signal path enables the first and the second optical components 810, 820 to be positioned at a larger distance from each other than in the embodiments with one single glass coupler body between the first and the second optical components. It also enables the first and the second optical components 810, 820 to be directed with the transmitting and receiving facets 812, 822 not necessarily facing towards each other. Thereby, an optical coupling arrangement with the first optical component comprising a semiconductor laser may be implemented as an External Laser System (ELS) type configuration.

Similarly to the coupler misalignment discussed above, there may be a non-zero first coupler misalignment between the converging member 831 of the first glass coupler boy and the transmitting facet 812 of the first optical component. Correspondingly, the second glass coupler body and the second optical component may be positioned with the second output facet 874 and the receiving facet 822 facing each other mutually misaligned by a non-zero second coupler misalignment. The possible first and/or second coupler misalignment may be in accordance with the coupler vertical and/or horizontal misalignments discussed above with reference to FIGS. 1a and 1b.

The optical coupling arrangement 800 of FIG. 7 serves to optically couple, with a coupling efficiency, the first and the second optical components 810, 820 by transmitting light of the light beam 814 emitted out of the transmitting facet 812 of the first optical component 810 to the second output facet 874 of the second glass coupler body 873 and further to the receiving facet 822 of the second optical component 810.

The coupling efficiency might be affected by the possibly non-zero first and/or second coupler misalignments, by possible difference between the first and the second numerical apertures, and/or by the converging characteristics. Advantageously, the optical coupling arrangement may be configured to compensate those adverse effects by properly designing and manufacturing the coupling waveguides 833, 873 in accordance with the coupler misalignments and the converging characteristics. The ways of designing the coupling waveguides may comprise to compensate those adverse effects may be similar or corresponding to those discussed above with reference to FIGS. 1a, 1b, 1c, and 2 to 6.

In the example of FIG. 7, the optical fiber 880 is connected to the first output facet of the first glass coupler body and to the second output facet of the second glass coupler body by connectors 880. The connectors may be configured in accordance with principles as such known in the field of optical fiber connectors or optical fiber cable connectors. In the example of FIG. 7, there are connectors with two connector elements at both ends of the optical fiber. Receiving connector elements 881a are mounted onto the first transmitting side surface 837 and the second receiving side surface 872 at predetermined locations of the first output facet 834 and the second input facet 875. They may be mounted before formation of the coupling waveguides 833, 873 in the first and the second glass coupler bodies. Mating connector elements 881b arranged at the ends of the optical fiber 880 are fastened to the receiving connector elements. In other embodiments, such connectors may be missing.

In the example of FIG. 7, the second optical component 820 comprises a PIC with a waveguide 821. In other embodiments, the second optical component may comprise, for example, an optical fiber.

The FIG. 7 embodiment is an implementation of an optical coupling arrangement with one group of a transmitting facet, a converging member, a first glass coupler body with a first coupling waveguide therein, an optical fiber, and a second glass coupler body with a second glass coupler body formed in one first glass coupler body. In other embodiments, optical coupling arrangements may be implemented with a plurality of such groups.

Such larger optical coupling arrangement may comprise a plurality of transmitting facets comprised in more or more first optical components. Correspondingly, there may be a plurality of receiving facets comprised in one or more second optical components. The number of the transmitting facets and the number of the receiving facets may be the same or different. A first or a second optical component may comprise a plurality of transmitting or receiving facets, respectively, which may be arranged in an array. Further, there may be one or more first glass coupler bodies and one or more second glass coupler bodies. Each of the first and the second glass coupler bodies may comprise any appropriate number of coupling waveguides therein, and the first and the second glass coupler bodies may be connected and optically coupled by any appropriate number of optical fibers.

An example of such optical coupling arrangement with multiple groups of different parts of the optical coupling arrangement is illustrated in FIG. 8. If not otherwise disclosed, the properties of the parts of the optical coupling arrangement 900 of FIG. 8 may be in accordance with the corresponding parts of the optical coupling arrangement 800 of FIG. 7.

There is a first optical component 910 having an array of first transmitting facets 912 in the example optical coupling arrangement 900 of FIG. 8. The first optical component comprises an array of optical elements 911 which may be or comprise, for example, semiconductor lasers. At the receiving side of the optical coupling arrangement, there is a second optical component 920 comprising four receiving facets 922.

In the example of FIG. 8, the first glass coupler body 930 of the first optical coupling element 901 comprises an array of four converging members 931 and four first coupling waveguides 960. The first glass coupler body may be in accordance, for example, with the glass coupler body 330 of FIG. 2 having a plurality of discrete coupling waveguides 333. In other embodiments, a plurality of first coupling waveguides may form joint waveguides such as those discussed above with reference to FIG. 6.

In the example of FIG. 8, there is a second glass coupler body 970 comprising four second coupling waveguides 973.

Four optical fibers 980 are connected to the first output facets 934 of the first glass coupler body and the second input facets 975 of the second glass coupler body to optically couple the first output facets and the second input facets.

In the example, of FIG. 8, the optical fibers 980 are incorporated within a fiber cable 990. The optical fiber cable 990 of the example of FIG. 8 is implemented as a ribbon cable. Although not illustrated in FIG. 8, the optical fiber 980 and the optical fiber cable 990 may be connected to the first output facets and/or the second input facets by any appropriate connector elements or connectors, such as those of FIG. 7.

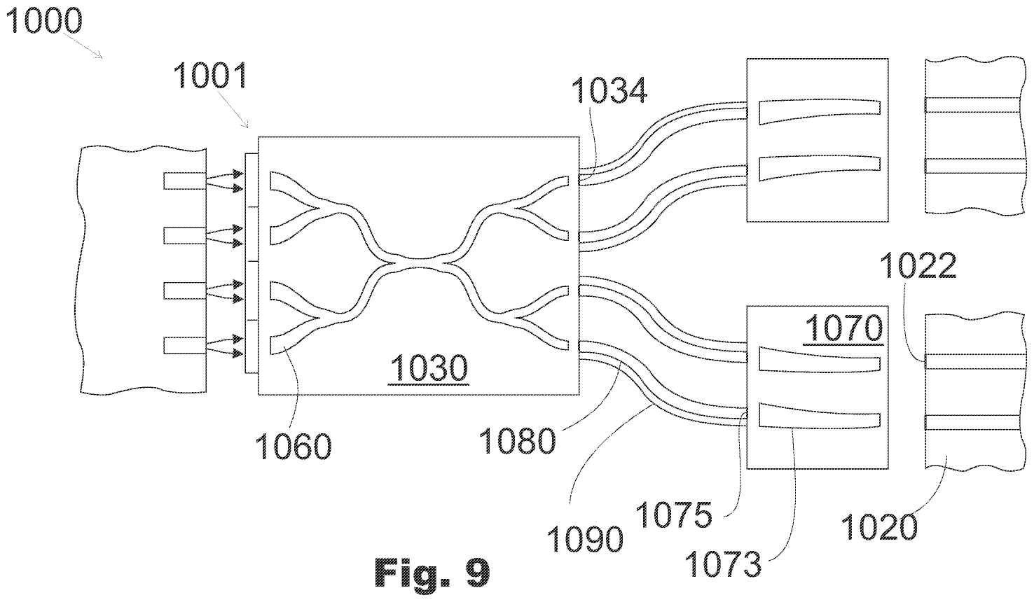

The optical coupling arrangement 1000 of FIG. 9 may be basically in accordance with those discussed above with reference to FIG. 8. It however distinguishes therefrom in the following aspects.

At the receiving side of the optical coupling arrangement, there are two second optical components 1020 each comprising two receiving facets 1022.

In the example of FIG. 9, the first glass coupler body 1030 comprises four first coupling waveguides 1060 forming joint waveguides. The first glass coupler body 1030 and the first coupling waveguides 1060 thereof may be in accordance with those discussed above with reference to FIG. 6.

In the example of FIG. 9, there are two second glass coupler bodies 1070, each comprising two second coupling waveguides 1073.

In the example of FIG. 9, the optical fibers 1080 connected to and coupling the first output facets 1034 and the second input facets 1075 are incorporated within two optical fiber cables 1090, such as ribbon cables, each comprising two optical fibers.

For the sake of clarity of the drawings, the optical cables and optical fibers thereof are illustrated in FIGS. 8 and 9 as being relatively short. In practice, they may be much longer than indicated in those schematic drawings.

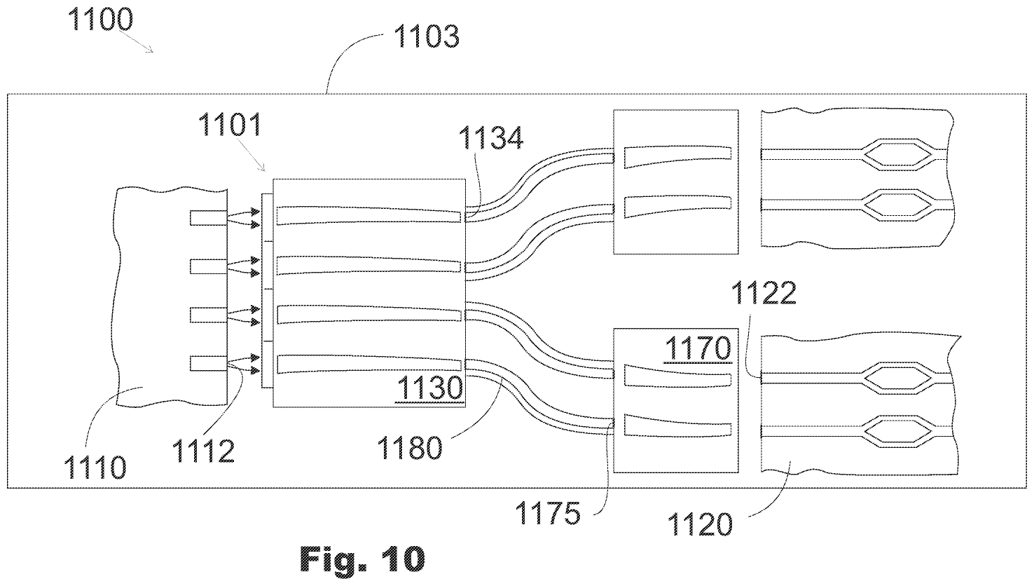

The optical coupling arrangement 1100 of FIG. 10 represents yet another example of multiple transmitting facets 1112 and receiving facets 1122 optically coupled by first and second glass coupler bodies 1130, 1170 and optical fibers 1180 therebetween.

Similarly to the example of FIG. 9, there are two second glass coupler bodies 1170 and two second optical components 1120 optically coupled by four optical fibers 1180. The first glass coupler body 1130 may be in accordance with that of FIG. 8.

In the example of FIG. 10, the second optical components 1120 comprise PICs with modulators, such as SiP MZM (Silicon Photonic Mach-Zehnder Modulator) modulators. In other embodiments, there may be other types of second optical elements.

The first and the second optical components 1110, 1120 as well as the first and the second glass coupler bodies 1130, 1170 are mounted on a common substrate or carrier 1103. Then, the optical fibers 1180 may be relatively short.

The common substrate or carrier 1103 may be or comprise a PCB. This may enable having electrical circuits and optical circuits of an electro-optical system incorporated in the same module or device.

In various embodiments, the optical coupling arrangement may comprise second optical components of different types and/or materials. For example, there may be several different PICs, possibly formed in, or of, different materials such as III-V compound semiconductors and silicon, on one single substrate of carrier. This may provide a flexible way to produce a single PCB with all the photonic components on it.

In the examples of FIGS. 8 to 10, the optical coupling arrangements comprise four transmitting facets and four receiving facets. These are examples of pluralities of transmitting facets and receiving facets; the actual numbers may vary, i.e. be different in different embodiments.

In the embodiments discussed above, the converging member serves for manipulating, controlling, and/or guiding light entering the glass coupler body or the first glass coupler body. Any glass coupler body, first glass coupler body, or second glass coupler body may further comprise any other optical element(s) such as a lens, configured to manipulate, control, and/or guide light entering or exiting it.

The lenses discussed above with reference to FIGS. 1, la, 1b, 1c, and 2 to 8 are refractive lenses. In other embodiments, a glass coupler body or a completed coupler or a coupling element with diffractive lens(es) as converging member(s) may be used or implemented.

It will be understood that the benefits and advantages described above may relate to one embodiment or example or may relate to several embodiments or examples. The embodiments and examples are not limited to those that solve any or all of the stated problems or those that have any or all of the stated benefits and advantages. It will further be understood that reference to ‘an’ item refers to one or more of those items.

Wherever in this specification a device, component, element, member, or another entity is specified being “configured to” “for” a specific operation, such entity may be considered being “for” carrying out that operation.

The term “comprising” is used in this specification to mean including the feature(s) followed thereafter, without excluding the presence of one or more additional features.

1. An optical coupling element configured to be positioned between and optically couple a first optical component configured to transmit a light beam, and a second optical component configured to receive light, the optical coupling element comprising a glass coupler body having a receiving side surface and an opposite transmitting side surface, the glass coupler body comprising:
a converging member configured to reduce, in accordance with converging characteristics, divergence of light entering the glass coupler body via the receiving side surface; and
a coupling waveguide extending within the glass coupler body between the converging member and an output facet on the transmitting side surface and being configured to transmit light from the converging member to the output facet.

2. An optical coupling element as defined in claim 1, wherein the converging member comprises a lens.

3. An optical coupling element as defined in claim 1, wherein the converging member forms a local extension outward of the receiving side surface.

4. An optical coupling element as defined in claim 1, wherein the coupling waveguide is configured to narrow towards the output facet.

5. An optical coupling element as defined in claim 1, wherein the coupling waveguide is configured to have a curved section.

6. An optical coupling element as defined in claim 1, wherein the coupling waveguide is configured to have a curved section narrowing towards the output facet.

7. An optical coupling element as defined in claim 1, wherein the coupling waveguide is configured to have a straight waveguide section having a substantially constant cross-section.

8. An optical coupling element as defined in claim 1, wherein the coupling waveguide has a first end at the side of the receiving side surface, the converging member has an optical axis and a receiving interface having a radius of curvature R at the optical axis, the first end lying at a converging member separation distance of 0.5 to 1.5 R, as defined along the optical axis, from the receiving interface.

9. An optical coupling element as defined in claim 1, wherein the glass coupler body has a cavity therein dividing the coupling waveguide into a first waveguide part between the cavity and the converging member, and a second waveguide part between the cavity and the transmitting face.

10. An optical coupling element as defined in claim 8, wherein the cavity has two opposite reflective surfaces lying tilted relative to the coupling waveguide to form a virtually imaged phase array VIPA configured to spatially separate multi-wavelength light entering the cavity from the first waveguide part into a first wavelength component transmitted to the second waveguide part and at least one additional wavelength component, the glass coupler body comprising at least one additional waveguide part between the cavity and the transmitting face positioned to receive the at least one additional waveguide component.

11. An optical coupling element as defined in claim 1, wherein the glass coupler body comprises an array of a plurality of converging members and a plurality of coupling waveguides between the converging members and a plurality of output facets on the transmitting side surface, each of the coupling waveguides comprising an input waveguide part, an intermediate waveguide part, and an output waveguide part, the intermediate waveguide parts of at least two coupling waveguides lying in a light coupling connection with each other enabling coupling of light signals between the at least two coupling waveguides.

12. An optical coupling element as defined in claim 11, wherein the intermediate waveguide parts of the at least two coupling waveguides form a joint waveguide.

13. An optical coupling arrangement comprising:
a first optical component having a transmitting facet, configured to transmit a light beam with a beam divergence corresponding to a first numerical aperture out of the transmitting facet;
a first optical coupling element in accordance with the optical coupling element as defined in claim 1, the converging member being configured to reduce the beam divergence of the light beam transmitted by the first optical component;
a second glass coupler body having a second receiving side surface and an opposite second transmitting side surface, the second glass coupler body comprising a second coupling waveguide extending within the second glass coupler body between a second input facet on the second receiving side surface and a second output facet on the second transmitting side surface and being configured to transmit light from the second input facet to the second output facet;
an optical fiber connected to, and optically coupling, the output facet of the first optical coupling element and the second input facet; and
a second optical component with a second numerical aperture, having a receiving facet, configured to receive light via the receiving facet;
the first optical coupling element and the first optical component being positioned with the converging member and the transmitting facet facing each other, and the second glass coupler body and the second optical component being positioned with the second output facet and the receiving facet facing each other, to optically couple, with a coupling efficiency, the first and the second optical components by transmitting light of the light beam to the second output facet and further to the receiving facet.

14. An optical coupling arrangement as defined in claim 13, wherein the second numerical aperture is smaller than the first numerical aperture.

15. An optical coupling arrangement as defined in claim 13, wherein the optical fiber is connected to at least one of the output facet of the glass coupler body of the first optical coupling element and the second input facet by a connector element mounted on the transmitting side surface of the glass coupler body of the first optical coupling element and/or on the second receiving side surface, respectively.

16. An optical coupling arrangement as defined in claim 13, wherein the first optical component comprises an active optical component.

17. An optical coupling arrangement as defined in claim 13, wherein at least one of the first and the second optical components comprises a waveguide of a photonic integrated circuit.

18. An optical coupling arrangement as defined in claim 13, wherein
the first optical component comprises an array of a plurality of transmitting facets, and the optical coupling arrangement comprises at least one second optical component comprising a plurality of receiving facets, and at least one second glass coupler body;
the glass coupler body of the first optical coupling element comprises an array of a plurality of converging members and a plurality of coupling waveguides between the converging members and a plurality of output facets on the transmitting side surface;
the at least one second glass coupler body comprises a plurality of second input facets on the second receiving side surface(s) thereof, and a plurality of second coupling waveguides between the input facets and a plurality of second output facets on the second transmitting side surface (s) thereof, the second output facets and the receiving facets facing each other; and
the optical coupling arrangement comprises a plurality of optical fibers connected to, and optically coupling, the output facets of the glass coupler body of the first optical coupling element and the second input facets.

19. An optical coupling arrangement as defined in claim 18, comprising at least two second glass coupler bodies each comprising at least one of the plurality of second coupling waveguides, and at least two second optical components each comprising at least one of the plurality of receiving facets.

20. An optical coupling arrangement as defined in claim 18, wherein at least two optical fibers of the plurality of optical fibers are incorporated within an optical fiber cable.
